(19) United States
(12) Patent Application Publication
(10) Pub. No.: US 2013/0054826 A1
(43) Pub. Date: Feb. 28, 2013

(54) TERMINAL AND METHOD FOR SHARING CONTENT

(71) Applicants: Jae Man HONG, Seoul (KR); Woo Young LEE, Seoul (KR)

(72) Inventors: Jae Man HONG, Seoul (KR); Woo Young LEE, Seoul (KR)

(73) Assignee: PANTECH CO., LTD., Seoul (KR)

(21) Appl. No.: 13/340,073

(22) Filed: Dec. 29, 2011

(30) Foreign Application Priority Data
Aug. 25, 2011 (KR) 10-2011-0085080

(51) Int. Cl. G06F 15/16

(52) U.S. Cl. 709/231

(57) ABSTRACT

A content share request terminal and a mobile communication terminal may transmit description information for sharing content according to a Digital Living Network Alliance (DLNA) scheme using a mobile communication network. Therefore, the content share request terminal and the mobile communication terminal may share content without performing a discovery procedure in the DLNA scheme.

### CROSS-REFERENCE TO RELATED APPLICATION

This application claims priority from and the benefit under 35 U.S.C. §119(a) of Korean Patent Application No. 10-2011-0085080, filed on Aug. 25, 2011, which is hereby incorporated by reference for all purposes as if fully set forth herein.

### BACKGROUND

1. Field

This disclosure relates to a terminal that may share content using a Digital Living Network Alliance (DLNA™) scheme without performing a discovery procedure.

2. Discussion of the Background

In general, a plurality of devices capable of playing back various types of contents may be installed in or near a place of residence or business. Such devices may include, without limitation, a personal computer (PC), a television (TV), a digital versatile disc (DVD) player, and the like. The contents may include, without limitation, a moving picture, a digital image, a music file, a multimedia file, and the like. If each device maintains or stores contents in the device's local or installed memory, a user may play back the stored content by employing the respective device that maintains or stores the content. That is, the user may need to use a PC to play back content provided in the PC, and may need to use a DVD player to play back content provided in the DVD player.

A content sharing scheme that enables sharing of contents between devices to enable a user to play back content using the user's desired device, even if that particular device may not maintain or store the respective content, has been proposed. A Digital Living Network Alliance (DLNA™) scheme is a standard that may enable a plurality of devices equipped within a house or an internal network to share contents included in the respective devices.

FIG. 1 is a diagram illustrating a DLNA™ scheme to support sharing of contents between various terminals using an access point. As shown in FIG. 1, terminal 130, terminal 140, terminal 150, terminal 160, terminal 170, and terminal 180 are included in a network configured using the same access point 120. One or more terminals illustrated in FIG. 1 may perform a discovery procedure to recognize the other terminals in the network.

For example, in the discovery procedure, the terminal 130 may broadcast description information including at least one of a list of sharable contents among contents included in the terminal 130, an Internet Protocol (IP) address of the terminal 130, and a content type playable at the terminal 130, over the network. One or more of other terminals in the network (i.e., terminal 140, terminal 150, terminal 160, terminal 170, and terminal 180) may receive the description information from the terminal 130 and recognize the terminal 130. The other terminals in the network may transmit their own description information to the terminal 130, and the terminal 130 may recognize the other terminals in the network by referring to the received description information. As shown in FIG. 1, the referenced terminals may include, without limitation, a server, a network router, a television (TV), a personal computer (PC), a mobile terminal, and the like.

Further, two or more terminals in the network (i.e., two of terminal 130, terminal 140, terminal 150, terminal 160, terminal 170, and terminal 180) may recognize each other through the discovery procedure and share their contents upon recognition.

In the DLNA™ scheme, a small access point enables content to be shared between terminals using a User Datagram Protocol (UDP)-multicast. However, in a large network that does not support the UDP-multicast, such as a mobile communication network, content cannot be shared.

### SUMMARY

Exemplary embodiments of the present invention provide a terminal and a method that may share content between terminals without performing a discovery procedure.

Additional features of the invention will be set forth in the description which follows, and in part will be apparent from the description, or may be learned by practice of the invention.

Exemplary embodiments of the present invention provide a method for sharing content between a first terminal and a second terminal including transmitting a connection request to the second terminal via a mobile communication network; receiving a response to the connection request from the second terminal via the mobile communication network; requesting to receive content stored in the second terminal; and receiving content transmitted by the second terminal.

Exemplary embodiments of the present invention provide a first terminal including a transmitter to transmit a connection request to a second terminal via a mobile communication network; a receiver to receive a response to the connection request from the second terminal via the mobile communication network; a content storage unit to store a content to be shared; and a content sharing unit to share the content with the second terminal.

Exemplary embodiments of the present invention provide a method for sharing content between a first terminal and a second terminal including transmitting a connection request from the first terminal to the second terminal via a network that does not support User Datagram Protocol (UDP)-multicast; receiving a description information of the second terminal via the network; requesting content stored in the second terminal; and receiving the content by the first terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a Digital Living Network Alliance (DLNA™) scheme to support sharing of contents between various terminals using an access point.

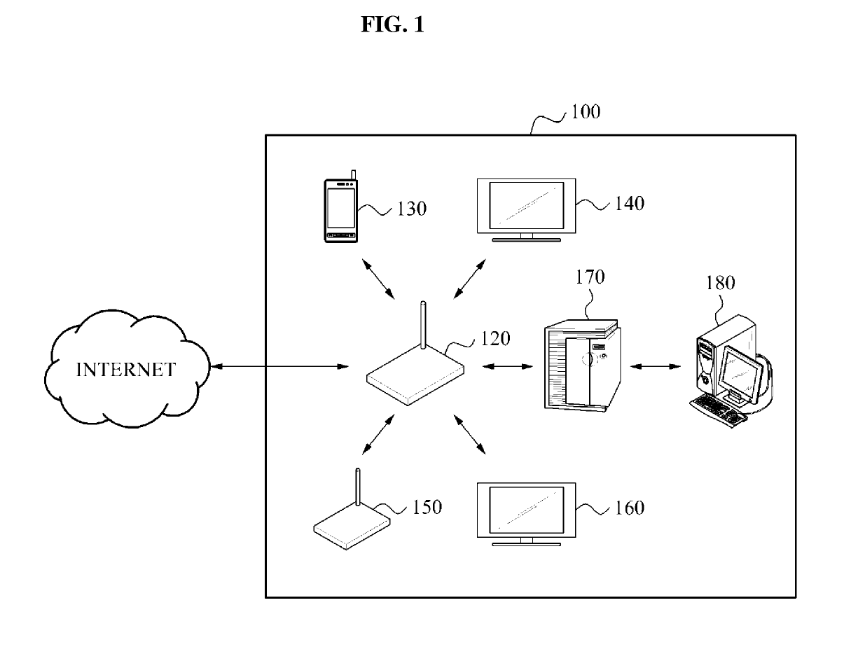

FIG. 2 is a diagram illustrating sharing of content between terminals using a mobile communication network according to an exemplary embodiment of the present invention.

FIG. 3 is a flowchart illustrating a method for sharing content between terminals using a multimedia messaging service (MMS) according to an exemplary embodiment of the present invention.

FIG. 4 is a diagram illustrating a user interface of a content share request terminal according to an exemplary embodiment of the present invention.

FIG. 5 is a diagram illustrating a user interface of a mobile communication terminal according to an exemplary embodiment of the present invention.

FIG. 6 is a flowchart illustrating a method for sharing content between terminals using a short message service (SMS) according to an exemplary embodiment of the present invention.

FIG. 7 is a diagram illustrating a system configuration to share content between various terminals according to an exemplary embodiment of the present invention.

FIG. 8 is a block diagram illustrating a mobile communication terminal according to an exemplary embodiment of the present invention.

FIG. 9 is a block diagram illustrating a content share request terminal according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

It will be understood that when an element is referred to as being “connected to” another element, it can be directly connected to the other element, or intervening elements may be present.

Hereinafter, exemplary embodiments of the present invention will be described with reference to the accompanying drawings.

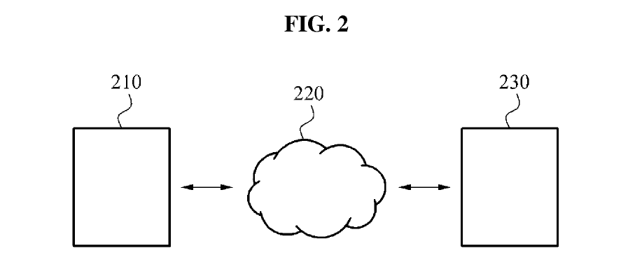

FIG. 2 is a diagram illustrates sharing of content between terminals using a mobile communication network according to an exemplary embodiment of the present invention.

A first terminal 210 may transmit first description information of the first terminal 210 to a second terminal 230 over a mobile communication network 220. The first terminal 210 may transmit the first description information to the second terminal 230 using a short message service (SMS) and/or a multimedia messaging service (MMS) that may be provided by the mobile communication network 220.

The first description information may include at least one of a list of sharable contents among contents included in the first terminal 210, an IP address of the first terminal 210, identification information of the first terminal 210, and a content type that may be executed or supported by the first terminal 210.

The second terminal 230 may receive the first description information, and may determine whether to share content with the first terminal 210. If the second terminal 230 determines not to share the content with the first terminal 210, the second terminal 230 may ignore the first description information and may not perform an additional operation.

If the second terminal 230 determines to share the content with the first terminal 210, the second terminal 230 may transmit second description information of the second terminal 230 to the first terminal 210 over the mobile communication network 220.

The second description information may include at least one of a list of sharable contents among contents included in the second terminal 230, an IP address of the second terminal 230, identification information of the second terminal 230, and a content type that may be executed or supported by the second terminal 230.

If the first terminal 210 receives the second description information and the second terminal 230 receives the first description information, the first terminal 210 and the second terminal 230 may recognize each other and share content. The first terminal 210 and the second terminal 230 may share contents included therein according to a Digital Living Network Alliance (DLNA™) scheme.

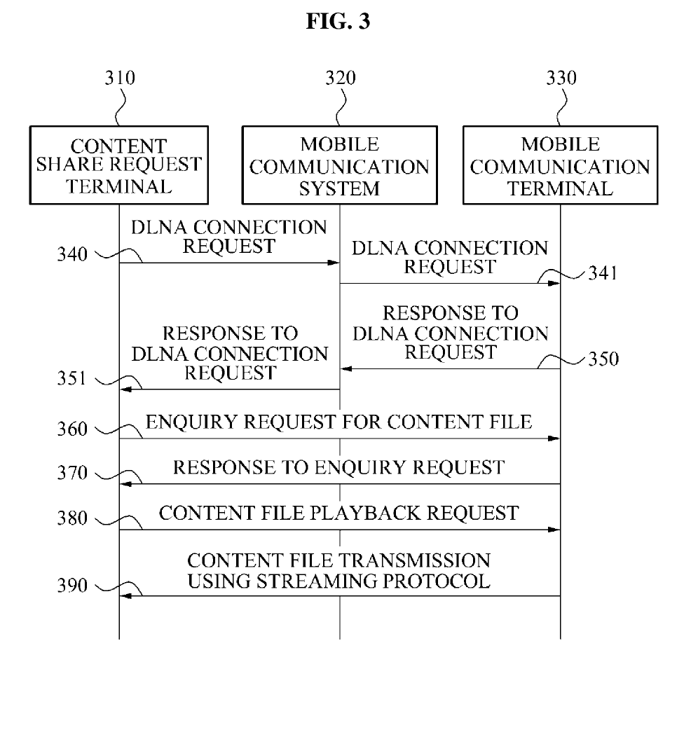

FIG. 3 is a flowchart illustrating a method for sharing content between terminals using an MMS according to an exemplary embodiment of the present invention.

In operation 340, a content share request terminal 310 may transmit a DLNA™ connection request to a mobile communication system 320 constituting a mobile communication network. The DLNA™ connection request may include first description information of the content share request terminal 310. The first description information may include at least one of a list of sharable contents among contents included in the content share request terminal 310, an IP address of the content share request terminal 310, identification information of the content share request terminal 310, and a content type that may be executed or supported by the content share request terminal 310.

The content share request terminal 310 may transmit the DLNA™ connection request using an MMS that may be provided by the mobile communication system 320. The first description information included in the DLNA™ connection request may be stored as an Extensible Markup Language (XML) file. In this case, the content share request terminal 310 may attach the first description information in a XML file format in an MMS message and transmit the same.

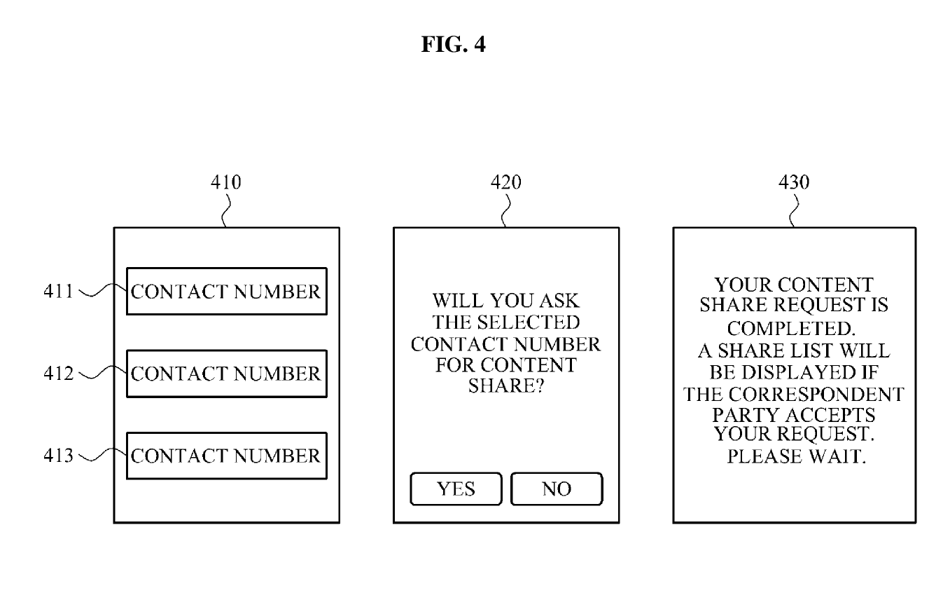

The MMS message transmitted using the MMS may include the first description information, and may additionally include indicator information to indicate that the first description information is included in the MMS message. Mobile communication terminal 330 may receive the MMS message and decode the indicator information, which may indicate that the first description information is included in the MMS message. The indicator information may be used to determine whether the first description information is included in the MMS message. A more detailed description of transmitting a DLNA™ connection request is provided in FIG. 4.

FIG. 4 is a diagram illustrating a user interface of a content share request terminal according to an exemplary embodiment of the present invention.

A contact number of the mobile communication terminal 330 may be stored in a phone book of the content share request terminal 310. In this case, a user of the content share request terminal 310 may load the phone book and the contact number of the mobile communication terminal 330 by manipulating the content share request terminal 310.

A screen 410 of FIG. 4 displays a phone book loaded on a screen of the content share request terminal 310. The user of the content share request terminal 310 may select one of loaded contact number 411, contact number 412, and contact number 413, to select a mobile communication terminal to share content with. Although contact numbers are illustrated to correspond to the various terminals, other identification information may be used as well (i.e., IP address, email address, and the like).

A screen 420 of FIG. 4 displays a screen inquiring the user about whether to share content with a mobile communication terminal corresponding to the selected contact number. If the user selects ‘no’, the content share request terminal 310 may not transmit a DLNA™ connect request to the selected mobile communication terminal. If the user selects ‘yes’, the content share request terminal 310 may transmit the DLNA™ connection request to the selected mobile communication terminal.

The content share request terminal 310 may display a screen 430 until a response to the DLNA™ connection request is received from the selected mobile communication terminal. In addition, the content share request terminal 310 may display the screen 430 for a reference period of time and then remove the screen 430. The content share request terminal 310 may enable the screen 430 to be verified on a separate screen.

Referring back to FIG. 3, in operation 341, the mobile communication system 320 may transmit the DLNA™ connection request to the mobile communication terminal 330.

The mobile communication terminal 330 may receive the DLNA™ connection request and parse the first description information included in the DLNA™ connection request. The mobile communication terminal 330 may determine whether to share content with the content share request terminal 310 based on the first description information.

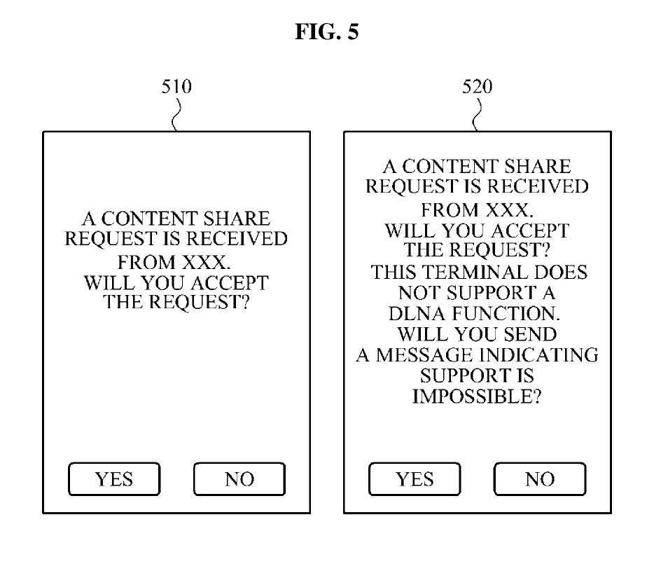

Further, if the DLNA™ connection request is received by the mobile communication terminal 330, a user of the mobile communication terminal 330 may determine whether to share content, as shown in FIG. 5, based on the determination whether the first description information is included in the MMS message.

FIG. 5 is a diagram illustrating a user interface of a mobile communication terminal according to an exemplary embodiment of the present invention.

As shown in a screen 510, the mobile communication terminal 330 may inquire the user of the mobile communication terminal 330 about whether to share content. If the user selects ‘no’, the mobile communication terminal 330 may not transmit a response to the DLNA™ connection request. If the user selects ‘yes’, the mobile communication terminal 330 may transmit the response to the DLNA™ connection request.

The mobile communication terminal 330 may not support content sharing operation using the DLNA™ scheme. In this example, the mobile communication terminal 330 may display a screen 520 to the user. The mobile communication terminal 330 may notify the user that the mobile communication terminal 330 does not support the content sharing operation using the DLNA™ scheme based on a selection of the user.

If the mobile communication terminal 330 does not support the content sharing operation using the DLNA™ scheme, the mobile communication terminal 330 may ignore the received DLNA™ connection request and may not display any message for the user.

If the user selects to share content with the content share request terminal 310, the mobile communication terminal 330 may transmit a response to the DLNA™ connection request to the mobile communication system 320. The mobile communication terminal 330 may transmit the response to the DLNA™ connection request using an MMS that may be provided by the mobile communication system 320. The response to the DLNA™ connection request may include second description information of the mobile communication terminal 330. The second description information may include at least one of a list of sharable contents among contents included in the mobile communication terminal 330, an IP address of the mobile communication terminal 330, identification information of the mobile communication terminal 330, and a content type playable at the mobile communication terminal 330.

The second description information included in the response to DLNA™ connection request may be stored as an XML file. In this case, the mobile communication terminal 330 may attach the second description information in the XML file format in an MMS message and transmit the same.

Referring back to FIG. 3, if a user of the mobile communication terminal 330 determines to share content, the mobile communication terminal 330 transmits a response to DLNA™ connection request to the mobile communication system 320 in operation 350. In operation 351, the content share request terminal 310 may receive the response to the DLNA™ connection request from the mobile communication system 320. The content share request terminal 310 may parse the second description information included in the DLNA™ connection request and determine whether to share content with the mobile communication terminal 330.

If both the content share request terminal 310 and the mobile communication terminal 330 determine to share content, the content share request terminal 310 and the mobile communication terminal 330 may share one or more contents included therein according to the DLNA™ scheme or other suitable schemes. Although the content share request terminal 310 is described as playing back content stored in the mobile communication terminal 330, the reverse case may also be applied.

Through operation 340, operation 341, operation 350, and operation 351, the content share request terminal 310 and the mobile communication terminal 330 may share content according to the DLNA™ scheme. Even though the DLNA™ connection request and a response thereto is performed using an MMS, the existing DLNA™ scheme may also be employed since the content share request terminal 310 and the mobile communication terminal 330 are aware of mutual IP addresses.

Sharing of content through a process after operation 360 may be similar to a content share using the conventional DLNA™ scheme and thus, will be briefly described.

In operation 360, the content share request terminal 310 may select reference content from among contents that may be available to be shared with the mobile communication terminal 330, and may transmit an enquiry request for a selected content file.

In operation 370, the mobile communication terminal 330 may respond to the enquiry request for the content file. More specifically, the mobile communication terminal 330 may agree to share the content file, or reject the request.

In operation 380, the content share request terminal 310 may transmit a content file playback request to the mobile communication terminal 330 if the mobile communication terminal 330 agrees to share the content file.

In operation 390, the mobile communication terminal 330 may transmit the content file to the content share request terminal 310 in response to the content file playback request. Also, in operation 390, the mobile communication terminal 330 may transmit the content file to the content share request terminal 310 using a streaming protocol.

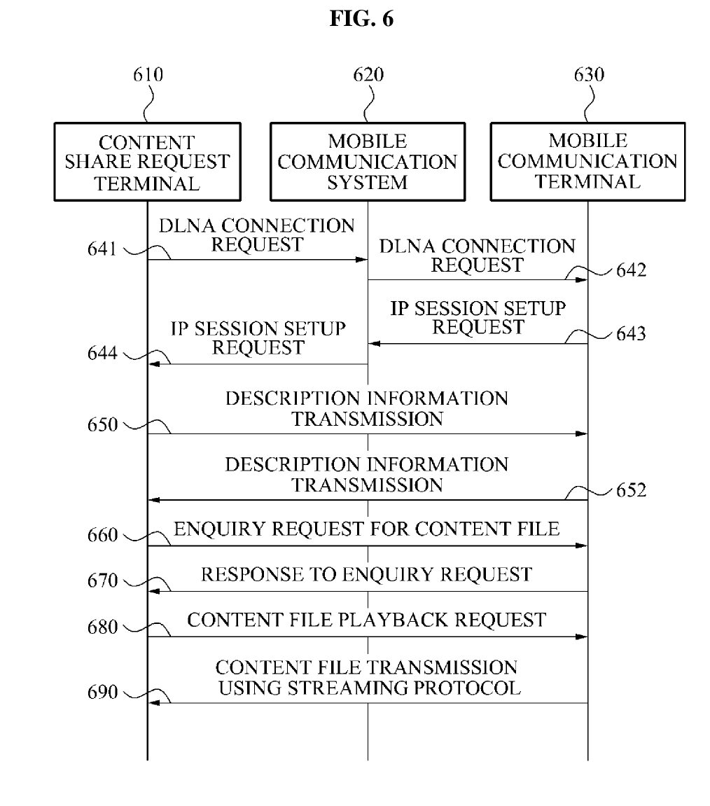

FIG. 6 is a flowchart illustrating a method for sharing content between terminals using an SMS according to an exemplary embodiment of the present invention.

A content share request terminal 610 and a mobile communication terminal 630 may transmit description information for a DLNA™ connection request as an attached file using an MMS, and may not transmit the attached file using an SMS. Therefore, as described above with reference to FIG. 3, the content share request terminal 610 and the mobile communication terminal 630 may transmit description information for a DLNA™ connection request as an attached file of the MMS message.

An exemplary embodiment in which the content share request terminal 610 and the mobile communication terminal 630 set up an IP session using the SMS and transmit description information using the IP session will be described with reference to FIG. 6.

In operation 641, the content share request terminal 610 may transmit a DLNA™ connection request to a mobile communication system 620. The content share request terminal 610 may transmit the DLNA™ connection request using an SMS that may be provided by the mobile communication system 620.

In operation 642, the mobile communication system 620 may transmit the DLNA™ connection request to the mobile communication terminal 630.

The mobile communication terminal 630 may determine whether to share content with the content share request terminal 610. Also, the mobile communication terminal 630 may display the DLNA™ connection request transmitted using the SMS to a user. The user may verify the displayed DLNA™ connection request and may input a selection about whether to share content with the content share request terminal 610.

If the mobile communication terminal 630 determines to share the content, or if a user of the mobile communication terminal 630 inputs a selection of sharing the content, the mobile communication terminal 630 may receive description information related to sharing contents from the content share request terminal 610.

The SMS message may not attach a file to be transmitted, which is different from the MMS. Therefore, the mobile communication terminal 630 may not receive a file that may include the description information using the SMS.

The mobile communication terminal 630 may receive description information by performing data communication with the content share request terminal 610. The content share request terminal 610 and the mobile communication terminal 630 may set up a data transmission path based on 1:1 correspondence, and may transmit description information using the data transmission path. The data transmission path connected based on 1:1 correspondence may be referred to as an IP session.

For the content share request terminal 610 and the mobile communication terminal 630 to set up an IP session, the mobile communication terminal 630 may request an IP address of the content share request terminal 610. Therefore, in operation 641 and operation 642, the content share request terminal 610 may transmit the IP address of the content share request terminal 610 to the mobile communication using the SMS.

In operation 643, the mobile communication terminal 630 may transmit an IP session setup request to the mobile communication system 620 using the SMS. The IP session setup request may include an IP address of the mobile communication terminal 630.

In operation 644, the content share request terminal 610 may receive, from the mobile communication system 620, the IP session setup request including the IP address of the mobile communication terminal 630.

The content share request terminal 610 and the mobile communication terminal 630 may generate an IP session in which the content share request terminal 610 and the mobile communication terminal 630 are connected with each other using mutual IP addresses.

In operation 650, the content share request terminal 610 may transmit first description information of the content share request terminal 610 to the mobile communication terminal 630 using the IP session.

In operation 652, the mobile communication terminal 630 may transmit second description information of the mobile communication terminal 630 to the content share request terminal 610. The content share request terminal 610 and the mobile communication terminal 630 may share contents included therein according to a DLNA™ scheme or other suitable schemes by referring to the first description information and the second description information.

In operation 660, operation 670, operation 680, and operation 690 of FIG. 6, the content share request terminal 610 and the mobile communication terminal 630 may share content according to a scheme similar to operation 360, operation 370, operation 380, and operation through 390 of FIG. 3 respectively. Thus, further detailed description will be omitted here.

In the aforementioned exemplary embodiments of FIG. 3, FIG. 4, FIG. 5, and FIG. 6, description information is transmitted via a mobile communication system, which may include a mobile communication network. A content share request terminal and a mobile communication terminal may transmit description information using an e-mail. For example, description information may be stored as a file in an XML format, and the content share request terminal and the mobile communication terminal may transmit the description information by attaching the description information in the e-mail.

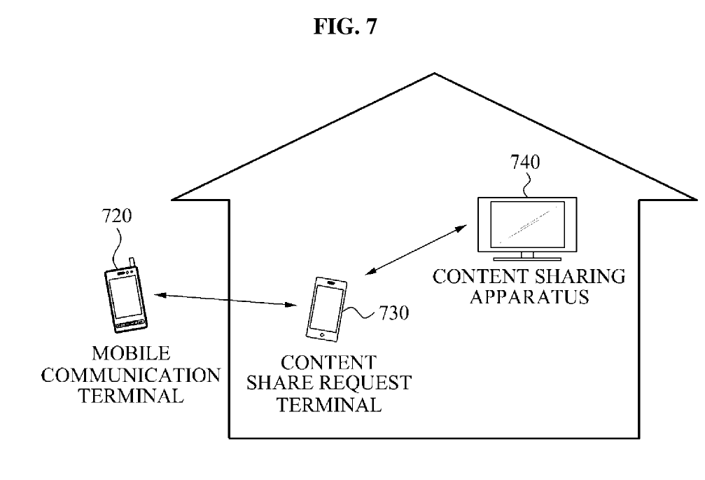

FIG. 7 is a diagram illustrating a system configuration to share content between various terminals according to an exemplary embodiment of the present invention. More specifically, FIG. 7 illustrates a mobile communication terminal 720 positioned outside of a house, which may be outside of an internal network setup inside of the house, and a content sharing apparatus 740 positioned within the house and its internal network via a content share request terminal 730 positioned within the house.

Referring to FIG. 7, the content share request terminal 730, which is positioned within the house, and the content sharing apparatus 740, which is also positioned within the house, may share content according to a DLNA™ scheme.

The mobile communication terminal 720 and the content share request terminal 730 may share content according to the DLNA™ scheme, as described above.

The mobile communication terminal 720 may receive information about the content sharing apparatus 740 via the content share request terminal 730, and may access content stored in the content sharing apparatus 740.

The mobile communication terminal 720 may control the content sharing apparatus 740 by employing the content share request terminal 730 as an access point.

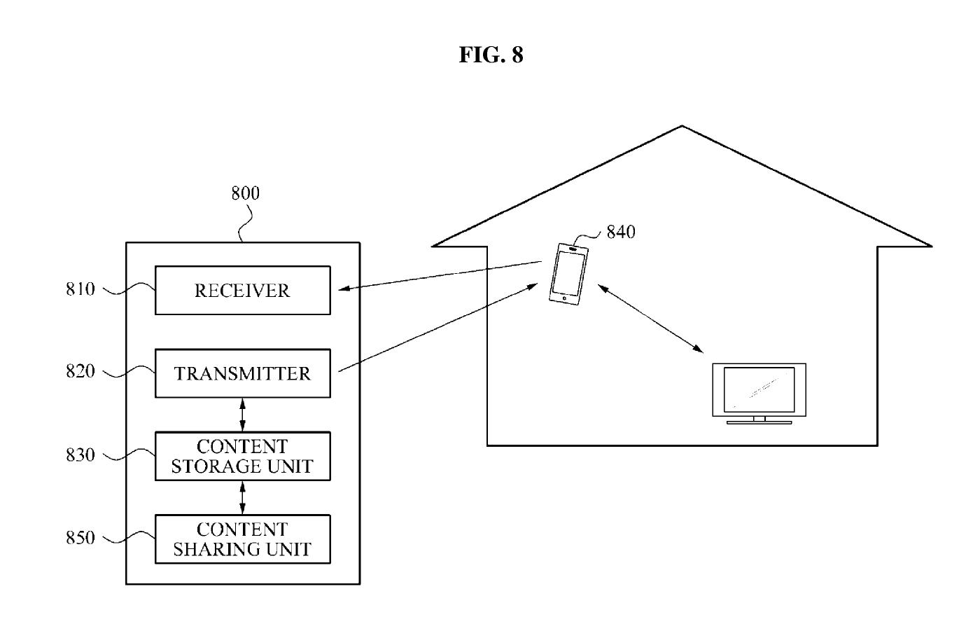

FIG. 8 is a block diagram illustrating a mobile communication terminal according to an exemplary embodiment of the present invention.

Referring to FIG. 8, the mobile communication terminal 800 may include a receiver 810, a transmitter 820, a content storage unit 830, and a content sharing unit 850.

The content storage unit 830 may store various types of contents, for example, multi-content data, a motion picture, a digital picture, a multimedia file and the like.

The receiver 810 may receive first description information of a content share request terminal 840 from the content share request terminal 840 via a mobile communication system, which may include a mobile communication network. The first description information may include at least one of a list of sharable contents among contents included in the content share request terminal 840, an IP address of the content share request terminal 840, identification information of the content share request terminal 840, and a content type playable at the content share request terminal 840.

In response to the first description information, the transmitter 820 may transmit second description information of the mobile communication terminal 800 to the content share request terminal 840 via the mobile communication system. The second description information may include at least one of a list of sharable contents among contents stored in the content storage unit 830, an IP address of the mobile communication terminal 800, identification information of the mobile communication terminal 800, and a content type that may be executable or supported by the mobile communication terminal 800.

The receiver 810 may receive a DLNA™ connection request message using an MMS. In this case, the receiver 810 may receive and parse an MMS message, and analyze the parsed MMS message to verify that the corresponding MMS message is a connection request message including the first description information.

If the mobile communication terminal 800 does not support content share using a DLNA™ scheme, the mobile communication terminal 800 may ignore the corresponding MMS message.

If the mobile communication terminal 800 supports the content share using the DLNA™ scheme, the mobile communication terminal 800 may display the corresponding MMS message, and may receive a selection of a user about whether to share content.

If the mobile communication terminal 800 receives the selection of the user, the transmitter 820 may attach the second description information in the MMS message format using an MMS of the mobile communication system to transmit the same.

The receiver 810 may receive a DLNA™ connection request message using an SMS of the mobile communication system. The receiver 810 may receive and parse an SMS message, and analyze the parsed SMS message to verify that the corresponding SMS message is the DLNA™ connection request message. If the SMS message cannot be attached with a file, the first description information may not be included in the SMS message. The SMS message may include an IP address of the content share request terminal 840.

A method for analyzing the SMS message to receive the selection of the user about whether to share content is similar to the method for analyzing the MMS and thus, further detailed description will be omitted.

If the mobile communication terminal 800 receives the selection of the user about whether to share content, the transmitter 820 may transmit, to the content share request terminal 840, an IP session setup request message. The IP session request message may be transmitted as the SMS message, which may include the IP address of the mobile communication terminal 800.

The mobile communication terminal 800 and the content share request terminal 840 may set up an IP session between the mobile communication terminal 800 and the content share request terminal 840 using the IP address of the mobile communication terminal 800 and the IP address of the content share request terminal 840.

The receiver 810 may receive the first description information from the content share request terminal 840 using the IP session, and the transmitter 820 may transmit the second description information to the content share request terminal 840 using the IP session.

The content sharing unit 870 may share content, stored in the content storage unit 830, with the content share request terminal 840 according to the DLNA™ scheme, by referring to the first description information and the second description information.

Even though not illustrated in FIG. 8, the mobile communication terminal 800 may further include an input unit and a display unit.

The input unit may receive a user's selection about whether to share content with the content share request terminal 840. Also, the display unit may display a request to receive the input from the user. A configuration of receiving the selection about whether to share content and displaying a request to receive an input is described above with reference to FIG. 4 and thus, further detailed description will be omitted here.

The input unit may search a phone book of the mobile communication terminal 800 for identification information of the content share request terminal 840 that is included in the received second description information. The display unit may display the request for input if the identification information of the content share request terminal 840 is found in the phone book.

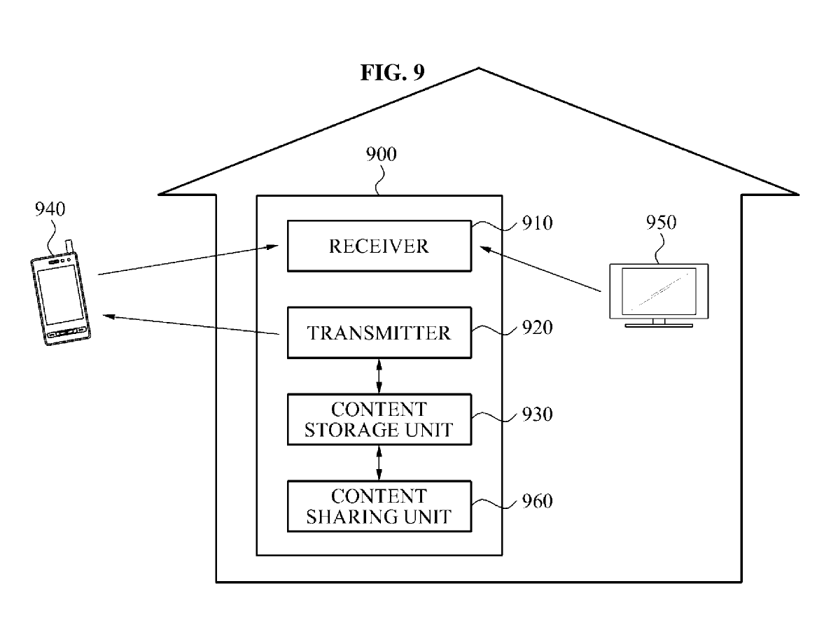

FIG. 9 is a block diagram illustrating a content share request terminal according to an exemplary embodiment of the present invention. Referring to FIG. 9, the content share request terminal 900 may include a receiver 910, a transmitter 920, a content storage unit 930, and a content sharing unit 960.

The content storage unit 930 may store content. Contents stored in the content storage unit 930 may be executed or supported by the content share request terminal 900 and may also be shared with a mobile communication terminal 940 to be executed or supported by the mobile communication terminal 940.

The transmitter 920 may transmit first description information of the content share request terminal 900 to the mobile communication terminal 940 via a mobile communication system, which may include a mobile communication network. The first description information may include at least one of a list of sharable contents among contents stored in the content storage unit 930, an IP address of the content share request terminal 900, identification information of the content share request terminal 900, and a content type that may be executable or supported by the content share request terminal 900.

In response to the first description information, the receiver 910 may receive second description information of the mobile communication terminal 940 via the mobile communication system. The second description information may include at least one of a list of sharable contents among contents included in the mobile communication terminal 940, an IP address of the mobile communication terminal 940, identification information of the mobile communication terminal 940, and a content type that may be executed or supported by the mobile communication terminal 940.

The first description information or the second description information may be stored as a file in an XML format. In this case, the transmitter 920 may attach the first description information in an MMS message of the mobile communication system and thereby transmit the same. The receiver 910 may receive the second description information attached in the MMS message of the mobile communication system.

Since the SMS message may not be attached with a file, the receiver 910 and the transmitter 920 may not directly receive or transmit description information using an SMS message of the mobile communication system.

The transmitter 920 may transmit an IP address of the content share request terminal 900 to the mobile communication terminal 940 to set up an IP session. The receiver 910 may receive an IP address of the mobile communication terminal 940 from the mobile communication terminal 940 using the SMS message.

The receiver 910 may receive the SMS message from the mobile communication terminal 940, and may parse the received SMS message. The receiver 910 may analyze the parsed SMS message to determine whether the IP address is included. The receiver 910 may set up the IP session between the content share request terminal 900 and the mobile communication terminal 940 using the IP address of the content share request terminal 900 and the IP address of the mobile communication terminal 940.

The transmitter 920 may transmit the first description information to the mobile communication terminal 940 using the IP session. The receiver 910 may receive the second description information from the mobile communication terminal 940 using the IP session. As described above, the content share request terminal 900 and the mobile communication terminal 940 may set up a data transmission path between the content share request terminal 900 and the mobile communication terminal 940 using the SMS message that may not support file attachment, and may share description information using the data transmission path.

The transmitter 920 may set up an IP session with respect to the mobile communication terminal 940 using the SMS of the mobile communication system. The transmitter 920 may transmit the first description information using the IP session and the receiver 910 may receive the second description information from the mobile communication terminal 940 using the IP session.

A content sharing unit 960 may share content, which may be stored in the content storage unit 930, with the mobile communication terminal 940 according to a DLNA™ scheme, by referring to the first description information and the second description information.

Even though not illustrated in FIG. 9, the content share request terminal 900 may further include an input unit and a display unit.

The input unit may receive a user's selection about whether to share content with the mobile communication terminal 940, and the transmitter 920 may transmit the first description information to the mobile communication terminal 940 based on the selection of the user.

The display unit may display a request to receive an input from the user. In response to the displayed request, the user may input whether to share content with the mobile communication terminal 940.

The content share request terminal 900 may be positioned within a house together with a content sharing apparatus 950, and the mobile communication terminal 940 may be positioned outside the house.

The content share request terminal 900 and the mobile communication terminal 940 may share content according to the DLNA™ scheme, as described above.

The mobile communication terminal 940 may receive information about the content sharing apparatus 950 via the content share request terminal 900, and may access content included in the content sharing apparatus 950. Here, the receiver 910 may receive content from the content sharing apparatus 950, and the transmitter 920 may transmit the received content to the mobile communication terminal 940.

The mobile communication terminal 940 may control the content sharing apparatus 950 by employing the content share request terminal 900 as an access point.

Thus, description information may be shared through transmitting and receiving a message between mobile terminals in a network in which a User Datagram Protocol (UDP)-multicast is unavailable, such as a mobile network or other networks that supports external or routable IP addresses, and this may enable the mobile terminals to share content.

According to exemplary embodiments, terminals may share content using a mobile communication network or another network, which may not support a User Datagram Protocol (UDP)-multicast.

According to exemplary embodiments, terminals may share content according to a Digital Living Network Alliance (DLNA™) scheme without performing a discovery procedure.

The exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for sharing content between a first terminal and a second terminal, comprising:
transmitting a connection request to the second terminal via a mobile communication network;
receiving a response to the connection request from the second terminal via the mobile communication network;
requesting to receive content stored in the second terminal; and
receiving content transmitted by the second terminal.

2. The method of claim 1, wherein the connection request is a Digital Living Network Alliance (DLNA) connection request comprising description information of the first terminal, and
the response to the connection request comprises description information of the second terminal.

3. The method of claim 1, wherein transmitting the connection request comprises selecting the second terminal according to its identification information.

4. The method of claim 2, wherein the description information is transmitted or received via a multimedia messaging service (MMS).

5. The method of claim 4, wherein the MMS message comprises indicator information to indicate a presence of description information in the MMS message.

6. The method of claim 2, wherein the description information is in an Extensible Markup Language (XML) file format.

7. The method of claim 2, wherein the description information is transmitted or received via e-mail.

8. The method of claim 1, wherein the content transmission is received according to a streaming protocol.

9. The method of claim 2, wherein the description information comprises at least one of a list of shareable contents, an internet protocol (IP) address, identification information, and a content type to be executed or supported.

10. The method of claim 1, further comprising:
receiving an IP session setup request in response to the connection request;
transmitting description information of the first terminal to the second terminal;
receiving description information of the second terminal; and
establishing an IP session.

11. A first terminal, comprising:
a transmitter to transmit a connection request to a second terminal via a mobile communication network;
a receiver to receive a response to the connection request from the second terminal via the mobile communication network;
a content storage unit to store a content to be shared; and
a content sharing unit to share the content with the second terminal.

12. The first terminal of claim 11, further comprising:
an input unit to receive a user input; and
a display unit to display a message related to the content to be shared.

13. The first terminal of claim 11, wherein the connection request is a Digital Living Network Alliance (DLNA) comprising description information of the first terminal, and the response to the connection request comprises description information of the second terminal.

14. The first terminal of claim 11, wherein the content sharing unit shares content according to a DLNA scheme.

15. The first terminal of claim 13, wherein the description information is transmitted or received via a multimedia messaging service (MMS).

16. The first terminal of claim 11, wherein the connection request comprises an internet protocol (IP) connection request, and the response to the connection request comprises a response to the IP connection request to establish an IP session.

17. The first terminal of claim 16, wherein description information of the first terminal or description information of the second terminal is transmitted or received through the IP session.

18. The first terminal of claim 11, wherein the content is shared with the second terminal according to a streaming protocol.

19. The first terminal of claim 13, wherein the description information comprises at least one of a list of shareable contents, an IP address, identification information, and a content type that may be executed or supported.

20. A method for sharing content between a first terminal and a second terminal, comprising:
transmitting a connection request from the first terminal to the second terminal via a network that does not support User Datagram Protocol (UDP)-multicast;
receiving a description information of the second terminal via the network;
requesting content stored in the second terminal; and
receiving the content by the first terminal.
